(19) United States
(12) Patent Application Publication
(10) Pub. No.: US 2018/0192681 A1
(43) Pub. Date: Jul. 12, 2018

(54) PACKAGED FOOD PRODUCTS CONTAINING ENTRAINED CO2

(71) Applicant: The Clorox Company, Oakland, CA (US)

(72) Inventors: Maria G. Ochomogo, Pleasanton, CA (US); Ashwini Wagh, Pleasanton, CA (US); Edith Ramos da Conceicao Neta, Pleasanton, CA (US); Kenneth L. Vieira, Pleasanton, CA (US); Vidya Ananth, Pleasanton, CA (US); Hubert Chan, Pleasanton, CA (US); Ashish K. Jha, Pleasanton, CA (US)

(21) Appl. No.: 15/843,409

(22) Filed: Dec. 15, 2017

Related U.S. Application Data
(60) Provisional application No. 62/445,093, filed on Jan. 11, 2017.

(51) Int. Cl. A23L 27/60; B65B 7/02; B65B 25/00

(52) U.S. Cl. CPC A23L 27/60; A23V 2002/00; B65B 25/001; B65B 7/02

(57) ABSTRACT

Packaged food compositions including but not limited to emulsified salad dressings (e.g., an oil/water emulsion) that contain calcium carbonate and phosphoric acid. Under conditions present in the salad dressing, the calcium carbonate reacts with the phosphoric acid to form surface modified calcium carbonate particles that dissolve over the shelf-life of the salad dressing to slowly release CO₂ into the emulsion, resulting in a whipped, bodied texture for the salad dressing within the bottle or other container.

### CROSS-REFERENCE TO RELATED APPLICATION

This application claims the benefit of U.S. Provisional Patent Application Ser. No. 62/445,093 filed on Jan. 11, 2017, entitled PACKAGED FOOD PRODUCTS CONTAINING ENTRAINED CO2, which is incorporated herein in its entirety by reference.

### BACKGROUND OF THE INVENTION

### 1. The Field of the Invention

The present invention relates to packaged food compositions (e.g., emulsified oil and water salad dressings and water-based salad dressings).

### 2. Description of Related Art

Many consumers enjoy salad dressing on salad or other food items. Typically, salad dressings are carefully formulated not only in terms of the edible components included therein to provide great taste, but other characteristics, such as pH, rheology, stability, and other factors are carefully selected to ensure characteristics other than taste are as desired. For example, such characteristics in addition to taste may include level of tartness (at least partially related to pH), pourability (related to rheology), and long term shelf stability. At the same time, there is an increased awareness by consumers of label ingredients included within such formulations, and a desire to avoid certain components that may be harmful, or perceived as harmful. Because of these constraints, it can be difficult to reformulate a salad dressing to remove or replace certain components, while still providing desired characteristics as described above.

### BRIEF SUMMARY

One aspect of the present invention relates to food product compositions, such as salad dressings, which include the ability to generate CO₂ in situ, which can act to alter the texture of the food product composition, providing it with a creamier, whipped texture. In the past, while efforts may have been made to inject CO₂ into similar food formulations after the formulation has already been prepared, such injection of CO₂ has not proven particularly effective, as the CO₂ may tend to rapidly escape from the formulation. In addition, any CO₂ that is successfully dissolved into the formulation upon initial packing may tend to leave the food product composition and accumulate in the headspace or other space between the interior wall of the bottle and the stored food product composition. In some circumstances, such a phenomenon may cause the bottle to bulge over time.

Many buffer materials previously employed in buffering packaged water-based or emulsified food compositions such as salad dressings to a desired pH have included ingredients that contain sodium (e.g., disodium phosphate). While such buffers may be effective, there is a growing preference from many consumers to avoid such sodium-containing ingredients. On the other hand, the inclusion of components that contain calcium may be perceived as beneficial by consumers. One aspect of the present invention provides a food product composition, e.g., a salad dressing, which may include calcium carbonate (e.g., as a buffer), and which also provides the ability to slowly (e.g., over the shelf-life of the product) generate CO₂ in situ, which may be largely present as very tiny bubbles, or simply dissolved in the aqueous phase and/or oil phase, if the food product composition contains oil, of the food product composition. For example, a food product composition may include an oil-water emulsion comprising oil and water. The food product composition may further include calcium carbonate and phosphoric acid. Phosphoric acid may be specifically selected, as it has been found by the present inventors to react with some of the calcium carbonate present and modify the surface of calcium carbonate particles, so as to create, in situ, a plurality of calcium carbonate particles having a phosphorus-modified surface (“surface modified calcium carbonate particles”). The surface modified calcium carbonate particles are only partially soluble in the food product composition. As the surface modified particles dissolve, they react and slowly release CO₂ into the food product composition at given pH values over an extended period of time (e.g., over the shelf-life of the product). Because the release of CO₂ occurs slowly, in very small amounts at any given time, the CO₂ is largely dissolved into the aqueous phase and/or oil phase of the food product composition (and believed to be present as extremely tiny bubbles suspended or aerated therein), i.e., homogeneously incorporated into the food product composition, rather than being present as relatively large bubbles, which may tend to coalesce and gather in the head space at the top of the bottle, or elsewhere between the bottle and the food product composition (causing the bottle to bulge due to pressure build-up).

The inventors have found that the formation of such surface modified calcium carbonate particles, which continue to exhibit relatively low solubility under the pH and other conditions present in the food product composition, e.g., salad dressing, allows this to occur. This phenomenon appears to be particularly associated with the combination of phosphoric acid and calcium carbonate, although it may be possible to achieve a similar effect with other calcium salts, and/or other carbonate salts.

Interestingly, the inventors have found that surface modified calcium carbonate particles do not form when calcium carbonate is combined with other food grade edible organic acids, such as acetic acid (vinegar), lactic acid, malic acid, citric acid, fumaric acid, adipic acid, and tartaric acid. When exposed to such other food grade edible acids, the calcium carbonate is quickly solubilized, quickly dissolving into the aqueous phase of the food product composition (e.g., salad dressing), which results in very fast release of the CO₂, and the associated bulging of the bottle, or loss of the CO₂ gas before bottling can be achieved. In other words, under such conditions, the CO₂ is generated rapidly, in a manner that consumes substantially all of the calcium carbonate within minutes, rather than allowing for slow release of CO₂.

Thus, the partial solubility of the surface modified calcium carbonate particles provides the ability to package the food product composition (e.g., salad dressing) in a manner in which allows CO₂ to be released into the food product composition (e.g., salad dressing) slowly, over an extended period of time (e.g., days, weeks, or months).

Another aspect of the present disclosure relates to methods of manufacturing a CO₂ containing food product composition in which the CO₂ gas is generated in-situ, rather than being injected into the formulation, e.g., immediately prior to packaging. Such a method may include providing an oil-water emulsion comprising oil and water, the oil-water emulsion further comprising calcium carbonate particles. Phosphoric acid may be added to the emulsion so as to form the food product composition, e.g., salad dressing. The phosphoric acid addition may occur at any time during the process, but in some circumstances it may be preferred to have the addition occur at or near the end of the formulation process, for example, just before packaging. The process may further include packaging the food product composition into a container (e.g., a bottle). The phosphoric acid reacts with the calcium carbonate to form surface modified calcium carbonate particles. If the food product composition is an emulsion, the surface modified calcium carbonate particles may be partially soluble in the emulsion (e.g., the oil phase, the aqueous phase or the oil/water interface thereof). Such methods could potentially be adapted for use in fat free or other formulations, e.g., where an emulsion may not necessarily be present (e.g., no oil phase, only an aqueous phase). In any case, the surface modified calcium carbonate particles slowly release CO₂ into the food product composition after packaging occurs, so that the slow release of CO₂ whips the composition, providing an increasingly creamy texture as the CO₂ is dissolved in the aqueous phase and/or the oil phase of the emulsion and producing a “CO₂ whipped food product composition”, e.g., a CO₂ whipped salad dressing. As used herein, the term “CO₂ whipped” refers to the situation where a food product composition contains surface modified calcium carbonate particles which slowly release CO₂ into the food product composition after packaging occurs, so that the slow release of CO₂ gives the food product a creamy texture.

Such food product compositions, including salad dressing formulations, and methods may provide a product that is comparable, or even preferable to those currently available, while at the same time providing an ingredients label that may be more attractive to consumers.

Further features and advantages of the present invention will become apparent to those of ordinary skill in the art in view of the detailed description of preferred embodiments below.

### BRIEF DESCRIPTION OF THE DRAWINGS

To further clarify the above and other advantages and features of the present invention, a more particular description will be rendered by reference to specific embodiments thereof which are illustrated in the drawings located in the specification. It is appreciated that these drawings depict only typical embodiments of the invention and are therefore not to be considered limiting of its scope. The invention will be described and explained with additional specificity and detail through the use of the accompanying drawings in which:

FIG. 1 is an SEM image showing calcium carbonate particles in their neat form;

FIG. 2A is an SEM image of the calcium carbonate particles after suspension in an aqueous solution mimicking the aqueous portion of an exemplary salad dressing formulation, including phosphoric acid, and having been dried, showing surface modification of the particles;

FIG. 2B is an SEM image of the dried calcium carbonate particles after suspension in an aqueous solution that included lactic acid instead of phosphoric acid;

FIG. 3 shows an EDX spectrum analysis of calcium carbonate particles modified with phosphorus, the spectrum showing the surface presence of calcium, phosphorus, and oxygen;

FIG. 4A shows FTIR spectra of calcium carbonate particles in their neat form (solid line) and after suspension in an aqueous solution mimicking the aqueous portion of an exemplary salad dressing, including phosphoric acid, and having been dried (dotted line), showing formation of calcium phosphate salts.

FIG. 4 shows rheology testing results of exemplary salad dressing formulations including phosphoric acid and calcium carbonate, showing how increasing calcium carbonate concentration decreases the viscosity of the salad dressing formulation as a result of increased in-situ CO₂ generation;

FIG. 5 shows test results for stability testing relative to how much CO₂ was in the headspace of packaged bottles of exemplary salad dressing formulations over a 10 week period;

FIGS. 6A-6B shows results of centrifugation testing that was conducted for an exemplary salad dressing formulation including calcium carbonate (FIG. 6A), as compared to a control without calcium carbonate (FIG. 6B).

### DETAILED DESCRIPTION OF THE PREFERRED EMBODIMENTS

### I. Definitions

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “buffer” includes one, two or more buffers.

Unless otherwise stated, all percentages, ratios, parts, and amounts used and described herein are by weight.

Numbers, percentages, ratios, or other values stated herein may include that value, and also other values that are about or approximately the stated value, as would be appreciated by one of ordinary skill in the art. A stated value should therefore be interpreted broadly enough to encompass values that are at least close enough to the stated value to perform a desired function or achieve a desired result, and/or values that round to the stated value. The stated values include at least the variation to be expected in a typical formulation process. Furthermore, the terms “substantially”, “similarly”, “about” or “approximately” as used herein represent an amount or state close to the stated amount or state that still performs a desired function or achieves a desired result.

Some ranges may be disclosed herein. Additional ranges may be defined between any values disclosed herein as being exemplary of a particular parameter. All such ranges are contemplated and within the scope of the present disclosure.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contains certain errors necessarily resulting from the standard deviation found in their respective testing measurements.

The term “food safe” refers to compositions, which are comprised entirely of materials that are considered food grade, and/or Generally Recognized As Safe (GRAS) and/or Everything Added to Food in the U.S. (EAFUS). In the United States, ingredients pre-approved for food use are listed in the United States Code of Federal Regulations (“C.F.R.”), Title 21. Food safe materials may also include ingredients that are well established as safe, have adequate toxicological and safety pedigree, can be added to existing lists, or approved via a self-affirmation process.

In the application, effective amounts are generally those amounts listed as the ranges or levels of ingredients in the descriptions, which follow hereto. Unless otherwise stated, amounts listed in percentage (“%'s”) are in weight percent (based on 100% active) of the food product composition (e.g., a salad dressing formulation). With respect to the salad dressing formulation, the terms “salad dressing formulation”, “salad dressing composition” and “salad dressing product” are used interchangeably herein. With respect to the food product composition, the terms “food product formulation”, “food composition” and “food product composition” are used interchangeably herein.

As used herein, the term “CO₂ entrained food composition” refers to the circumstance described in paragraph [0004] herein where the release of CO₂ into the food product composition occurs slowly, in very small amounts at any given time.

As used herein, the term “CO₂-whipped” refers to the situation where a food product composition contains surface modified calcium carbonate particles which slowly release CO₂ into the food product composition after packaging occurs, so that the slow release of CO₂ gives the food product a creamy texture.

As used herein, the term “shelf-stable” means a food that can safely be stored at room temperature in a sealed container.

As used herein, the term “shelf-life” means the length of time a commodity may be stored without becoming unfit for use, consumption, or sale.

As used herein, the term “slow release of CO₂” means that chemical reactions within a food composition slowly create CO₂ and that CO₂ is slowly dissolved into the food composition.

As used herein, the term “packaged food product” means an edible composition such as a dressing, sauce, dip, etc. that is in a sealed container such as a bag, bottle, pouch, etc. The container may comprise plastic, glass, metal, or any other material known to those in the food industry.

As used herein, the term “food ingredients” means ingredients listed on the label of a packaged food product in compliance with United States Food and Drug Administration (FDA) regulations.

As used herein the term “AOAC method” means a method found at the following web address http://www.aoac.org/aoac_prod_imis/AOAC/Publications/Official_Methods_of_Analysis/A OAC_Member/Pubs/OMA/AOAC_Official_Methods_of_Analysis.aspx?hkey=5142c478-ab50-4856-8939-a7a491756f48.

As used herein, the term “surface-modified particle” means that the uniform chemical composition of a particle's surface is modified through the incorporation of new elementsions/compounds, etc. to yield an altogether new particle.

As used herein, the term “in-situ generation” means generation of a new chemical substance in a product composition.

The phrase “substantially free of” as used herein, unless otherwise specified means that the composition comprises less than about 5%, preferably less than about 3%, more preferably less than about 1% and most preferably less than about 0.1% of the stated ingredient. The term “free of” as used herein means that the composition comprise as close to 0% of the stated ingredient as possible understanding that the ingredient may incidentally form as a byproduct or a reaction product of the other components of the composition or may be incidentally present within an included ingredient, e.g., as an incidental contaminant.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

### II. Introduction

Disclosed herein are food product compositions, and examples of salad dressing compositions, in which CO₂ gas is generated in-situ, within the food product composition, after it has been packaged, over an extended period of time, and at a relatively slow rate, so that the generated CO₂ results in a creamier texture (aka “CO₂-whipped”) to the food product until the end of shelf-life. Because the CO₂ is not generated substantially all at once, and because its generation occurs slowly as modified calcium carbonate particles slowly dissolve, the bottle in which such food product composition is packaged does not tend to bulge, as might otherwise occur where the contents become overly pressurized as a result of very fast generation of CO₂ gas. Instead, the CO₂ gas is generated at some slow, substantially constant rate, in a manner that the continuous small volume of in-situ generated CO₂ is able to be dissolved in the aqueous phase and/or oil phase of the food product composition. Such dissolved CO₂ may not make any significant contribution to the pressure in the headspace of the bottle, as it is dissolved. Of course, some CO₂ may make its way into the headspace over time, in equilibrium with CO₂ dissolved in the aqueous and/or oil phases. In some embodiments, as will be described herein, the headspace may be injected with another inert gas, such as nitrogen (N₂).

Inclusion of the calcium carbonate in the place of traditionally employed sodium containing buffers (e.g., disodium phosphate) reduces the sodium content of the salad dressing, and increases the calcium content of the salad dressing, providing an ingredient label which is more appealing to consumers.

It has also been found that such formulations can be further improved by removing other components that are problematic for some consumers. For example, monosodium glutamate (MSG) is included in many prepared food products as a flavor enhancer, and for other purposes. The present inventors have found that MSG also acts as a buffer, effectively raising the pH of salad dressing, when it is present.

Existing salad dressing formulations often require careful control over pH, keeping it greater than 3, preferably within a range greater than 3 and lower than 4.6, e.g., about 3.4 to 4.0. The tartness of the salad dressing formulation is related to its pH such that too low of a pH can lead to a formulation which is too tart to appeal to consumers.

The present inventors have advantageously found that comparable, appropriate tartness can be achieved in the presently disclosed formulations without MSG by including calcium carbonate and phosphoric acid (which react to form surface modified calcium carbonate particles) in the formulation. The resulting pH values of the formulation are lower than typically allowed. For example, the pH can be less than 3, e.g., within a range of 2.2 to 2.9. Of course, where desired, the traditionally employed higher pH values such as those referenced above can be provided in the presently disclosed formulations by simply including an appropriate buffer or by using other known mechanisms for providing the desired pH.

### III. Exemplary Salad Dressing Formulations

A. Water, Oil, Calcium Carbonate, and Phosphoric Acid Components

Embodiments of the present salad dressing formulations include water, optionally oil (e.g., present as an oil-water emulsion), calcium carbonate, and phosphoric acid. Water in the case of a fat-free formulation or the oil-water emulsion in the case of a traditional salad dressing formulation along with other standard components (e.g., herbs, spices, edible acids such as vinegar and citric acid, etc.) included within the salad dressing formulation may be according to traditionally employed, existing formulations, and the parameters of such will be appreciated by those of skill in the art.

In at least some embodiments, the salad dressing formulation may be a dairy-based salad dressing (e.g., Ranch salad dressing). U.S. Pat. No. 4,927,657 to Antaki, herein incorporated by reference in its entirety, describes salad dressing preservative systems that are particularly compatible with dairy-based salad dressings, or other mild flavor dressings, which employ particular combinations of edible acids and buffering salts. While Antaki provides the ability to provide acceptable shelf-life stability in the disclosed preservation systems, it requires a relatively high pH (e.g., 3.2 to 3.9) in order to provide an appropriate level of tartness (i.e., mild, low tartness) as required by consumers in mild, dairy-based salad dressings.

The present inventors have found a way to allow the pH to drop, by removing MSG while still providing the same relatively mild, low degree of tartness, all while still ensuring that the salad dressing is properly preserved for the given shelf-life of the salad dressing food product. While higher pH values such as those described above (e.g., 3.2 to 3.9) can be provided within the present formulations, the higher pH values are not required (as in Antaki) in order to ensure proper tartness. This allows the manufacturer additional freedom in formulating the salad dressing formulation, beyond that previously available.

Generally speaking, the amount of water in a formulation may be stated conversely as the amount of oil in a formulation, as the oil and water may make up the vast majority of the formulation constituents. Generally, when the amount of oil in a formulation is decreased (e.g., for reduced calorie purposes), the oil may be replaced with water. As such, it will be apparent that the oil/water ratio may be dependent upon the desired caloric content of the product, with reduced oil and increased water content in reduced calorie formulas. For a fat-free salad dressing formulation, no oil may be added, but rather just water (i.e., replacing the typical oil/water emulsion with just water).

All else being equal, increased water content may increase the potential for microbiological activity, increasing demands on the preservative system employed in such formulations. Altering the oil/water ratio may also affect the rheology characteristics of the product, affecting pourability, spoon-ability and similar characteristics, with increased oil content typically correlating to increased thickness and viscosity. The oil/water ratio may also affect the “mouth feel” of the product (i.e., the perceived creaminess and texture of the dressing).

Any suitable edible oils may be used in an oil-water emulsion of the salad dressing. Typical examples include triglyceride oils derived from oil seeds, for example, corn oil, soybean oil, safflower oil, cottonseed oil, the like, and mixtures thereof. The amount of oil present in a salad dressing formulation may vary from 0% (for a fat free formulation) to about 90% or more, typically in amounts up to about 70%. In some embodiments, the amount of oil may be from about 40% to about 90% by weight.

The water content may vary from about 5% to about 90%, from about 5% to about 50% by weight, e.g., from about 30% to about 90% for pourable or squeezable formulations, and from about 5% to about 65% for relatively thicker formulations such as those intended to be spooned out of the container (such formulations can also be dispensed by inverting and squeezing the container).

In some embodiments, the amount of calcium carbonate (or other carbonate salt, or other calcium salt) may be from 0.01% to 2% (or any range therebetween).

In some embodiments, the amount of phosphoric acid may be from 0.01% to 2%, (or any range therebetween).

Although the use of calcium carbonate and phosphoric acid is described herein in the context of salad dressing formulations including an oil-water emulsion, it is within the scope of the invention to use the concepts described herein in other food product formulations, such as dips, sauces or spreads, or in formulations which may include little or no oil component, or a salad dressing in which the oil and aqueous phases intentionally separate (e.g., Italian salad dressing), depending on the particular characteristics desired in the salad dressing or other food product composition (such as a vegetable dip, sandwich spread, sauce, marinade, etc.).

Edible acids suitable for use in salad dressing formulations typically include soluble, partially soluble, sparingly soluble, and substantially insoluble mineral and organic acids, including combinations of acids. Corresponding conjugate acid salts of such acids may also be suitable, including, but not limited to mono-carboxylic acids, di-carboxylic acids, tri-carboxylic acids, nitrogen based acids, and combinations thereof. Specific examples of such edible acids include acetic acid (vinegar), lactic acid, adipic acid, aspartic acid, alpha-hydroxyglutaric acid, citric acid, folic acid, fumaric acid, glutamic acid, glutaric acid, 3-hydroxyaspartic acid, malic acid, maleic acid, malonic acid, oxalic acid, oxaloacetic acid, petrin acid, proprionic acid, succinic acid, tartaric acid, tartronic acid, uric acid, derivatives or isomers of any of the foregoing, conjugate salts thereof, or combinations thereof. Food grade versions of lactic acid and acetic acid may be typically seen in other salad dressing formulations.

The present formulations employ phosphoric acid, which may be added to the food product formulation at any time after the calcium carbonate buffering salt, but is commonly added near the end of its preparation. As discussed, CO₂ is slowly generated in-situ as a byproduct of the reaction that occurs between the phosphoric acid and the calcium carbonate to form surface modified calcium carbonate particles.

Even under the acidic conditions typically present (e.g., a pH of about 3 or less), the surface modified calcium carbonate particles do not dissolve quickly in the aqueous environment, but remain only partially soluble, and dissolve slowly over time, due to equilibrium considerations and reactions occurring in the bottle or other container after packaging has occurred. In some embodiments, the formulation may be free of lactic acid, acetic acid, or other acids (e.g., in some embodiments, phosphoric acid may be the only added acid).

As described herein, the specific use of phosphoric acid and calcium carbonate has been found to result in the formation of surface modified calcium carbonate particles, which remain largely insoluble within the food product composition, but due to existing equilibrium forces, the surface modified particles slowly dissolve over the shelf-life of the product, slowing releasing CO₂ over an extended period of time. Such slow, consistent release of CO₂ within the food product composition itself results in generated micro-volumes of CO₂ becoming dissolved (e.g., dissolved in the aqueous phase and in the oil phase of an emulsified dressing), rather than contributing to any significant increase in pressure within the bottle or other container, which would cause the container to bulge. Such dissolved CO₂, rather than macro volumes of CO₂, which would itself separate as a distinct phase rising to the headspace, results in “whipping” of the food product composition (i.e., increasing the creaminess of the texture, and providing the desired creamy mouth feel to the food product composition). The emulsion thus may be characterized as including 3 phases—the water phase, the oil phase, and a dissolved CO₂ phase, dissolved within one or both of the other phases.

The dissolved CO₂ may be present in the aqueous phase in amounts up to the solubility limits, e.g., about 1,500 ppm (e.g., at 1 atm. and 25° C.). At somewhat higher pressures, and/or lower temperatures, the concentration of dissolved CO₂ may be relatively higher. For food product compositions containing oil, the CO₂ generated in-situ is also soluble in the oil phase of the composition, e.g., in an amount of up to about 2,000 ppm (e.g., at 1 atm. and 25° C.). At somewhat higher pressures, and/or lower temperatures, the concentration of dissolved CO₂ may be relatively higher.

Such is advantageous from several perspectives. First, the food product composition may be capable of tolerating significant CO₂ concentrations in the bulk product before build-up of any appreciable excess pressure in the headspace of a sealed bottle or other container occurs. For example, 1000 ppm CO₂ is 0.1%, and 2000 ppm is 0.2%. CO₂ that is dissolved in either the aqueous phase or the oil phase does not contribute to any significant increase in headspace pressure within the bottle or other container, which pressure would eventually result in bulging, particularly when the food product composition is packaged within plastic bottles (e.g., polyethylene terephthalate (PET)). The present methods and formulations thus allow introduction of CO₂ into food product compositions without relying on attempting to force CO₂ gas under high pressure into the food product composition. Such methods of forceful infusion of CO₂ are difficult to control, as the CO₂ tends to quickly diffuse out of the composition, even if initial infusion were successful. As a result, bottles of food product compositions infused with CO₂ in this manner will either tend to quickly lose any dissolved CO₂ content, to bulge under build-up of CO₂ pressure which does not remain dissolved, or both.

The present methods and compositions instead allow in-situ formation of CO₂ within the food product formulation itself, slowly, over time, beginning at the time of phosphoric acid addition. Thus, there is no attempt to quickly infuse a relatively large volume of CO₂ gas into the composition all at once, but rather the CO₂ is generated in substantially continuous, small amounts over a very long period of time. This allows a much larger fraction of the generated CO₂ to be effectively dissolved into the composition than would occur when attempting to infuse all of the CO₂ into the composition all at once.

In addition to thus allowing and providing relatively high concentrations of CO₂ within the aqueous and oil phases of the food product compositions (e.g., up to the solubility limits), the relatively high solubility of CO₂ in the oil phase can serve to displace oxygen that may otherwise be dissolved in the oil phase. Such dissolved oxygen in the oil phase is undesirable, as it can be responsible for oxygen-initiated free radical degradation of the oil (i.e., oxidation of the oil). Such oxidation of the oil may cause the oil to go rancid, which of course is undesirable. Thus, the relatively high concentration of CO₂ in the oil phase, which is continuously being augmented as the surface modified calcium carbonate particles continue to slowly dissolve (releasing CO₂), provides a preserving function, to increase the shelf-life of the food product composition without increasing the use of other preservatives, or allowing use of less such traditional preservatives. Such reduced need for preservatives further allows the manufacturer to provide a food product composition with less undesired ingredients, which result is greatly appreciated by consumers.

B. Exemplary Reactions

For simplicity, the exemplary reactions disclosed herein are described in relation to a salad dressing formulation, but it should be appreciated by those skilled in the art that the same reactions are expected to occur in other similar food product compositions (e.g., dips, sauces, spreads, marinades, etc.)

Where calcium carbonate and phosphoric acid are present in adressing emulsified food product formulation, several reactions are believed to occur, with equilibrium between the various chemical species so as to result in slow dissolution of the partially soluble surface modified calcium carbonate particle in the aqueous phase. Such reactions include:

H₃PO₄+H₂O↔H₂PO₄⁻+H₃O⁺ (Reaction 1)

In reaction (1), the added phosphoric acid dissociates into dihydrogen phosphate ions (H₂PO₄⁻) and hydrogen or hydronium ions (H₃O⁺). With a pKa value of about 2.16 at 25° C., phosphoric acid will likely be more than 50% dissociated within the typically contemplated pH ranges (e.g., greater than 2 and lower than 4). Phosphoric acid may thus supply the vast majority of free protons (H⁺) in solution and will likely be a major contributor to the overall pH and level of titratable acidity (TA).

The calcium carbonate particles may slowly dissolve in the aqueous phase, producing calcium ions and carbonate ions, as shown in reaction 2, below.

CaCO₃₍ₛ₎↔CaCO_{3(aq)}↔Ca²⁺+CO₃²⁻ (Reaction 2)

The carbonate ion (CO₃²⁻) is too strong a base to survive in the environment of the composition, and will rapidly neutralize a H⁺ from solution to form bicarbonate ion, as shown in Reaction 3a, below.

CO₃²⁻+H₃PO₄°HCO₃⁻+H₂PO₄⁻ (Reaction 3a)

HCO₃⁻+H₃PO₄↔H₂CO₃+H₂PO₄⁻ (Reaction 3b)

In this particular pH region of the food product formulation, the bicarbonate ion (HCO₃⁻) is also too strong a base, and will rapidly neutralize another H⁺ from solution to form carbonic acid H₂CO₃, as shown in reaction 3b.

Carbonic acid is unstable and decomposes to water and carbon dioxide, as shown in reaction 4, below.

H₂CO₃↔H₂O+CO_{2(g)}↑ (Reaction 4)

Surface modified calcium carbonate particles are believed to be generated through metathesis of a carbonate salt and an acid. The surface of the relatively insoluble CaCO₃ particle may be modified in the presence of H₃PO₄ and associated species, resulting in a newly formed relatively insoluble mixed (i.e., phosphorus modified) salt species. Such is expected to have the effect of changing the properties of the calcium carbonate particle, including particle morphology, shape, dissolution characteristics, and other properties. For example, metathesis is believed to occur at the surface of the CaCO₃ particle as shown in Reactions 5 and 6, below.

CaCO₃₍ₛ₎+2H₃PO_{4(aq)}→Ca(H₂PO₄)₂₍ₛ₎+H₂CO_{3(aq)} (Reaction 5a)

Ca(H₂PO₄)₂₍ₛ₎↔Ca²⁺_{(aq)}+2H₂PO_{4(aq)}⁻ (Reaction 5b)

CaCO₃₍ₛ₎+H₂CO_{3(aq)}→Ca(HCO₃)₂₍ₛ₎ (Reaction 6a)

Ca(HCO₃)₂₍ₛ₎↔Ca²⁺_{(aq)}+2HCO_{3(aq)}⁻ (Reaction 6b)

The dissolution of these surface modified, mixed salts, e.g., as shown in reactions 5b and 6b would retard further dissolution of calcium carbonate particles via the “common ion effect”, thereby stabilizing the level of CO₂, the pH, and the TA characteristics. Other mechanisms may also be at least partially responsible for the observation that the surface modified calcium carbonate particles remain largely insoluble, so as to dissolve slowly, over the shelf-life of the product rather than undergoing rapid dissolution and CO₂ generation. For example, the presence of phosphorus on the particle surface may alter solubility of the particle, rendering it relatively more insoluble.

Mechanisms by which surface modification other than those described above are possible. For example, the dihydrogen phosphate ion (H₂PO₄⁻) formed in reaction 1 or otherwise present from the other reactions may be able to combine with the calcium carbonate in one or more ways. For example, the dihydrogen phosphate ion may combine with a calcium ion in solution to form calcium dihydrogen phosphate Ca(H₂PO₄)₂, which salt is soluble in water under typical conditions up to about 2% by weight, at ambient temperature (e.g., 20° C. to 25° C.). This reaction is shown below, as reaction 7.

Ca²⁺+2H₂PO₄⁻→Ca(H₂PO₄)₂ (Reaction 7)

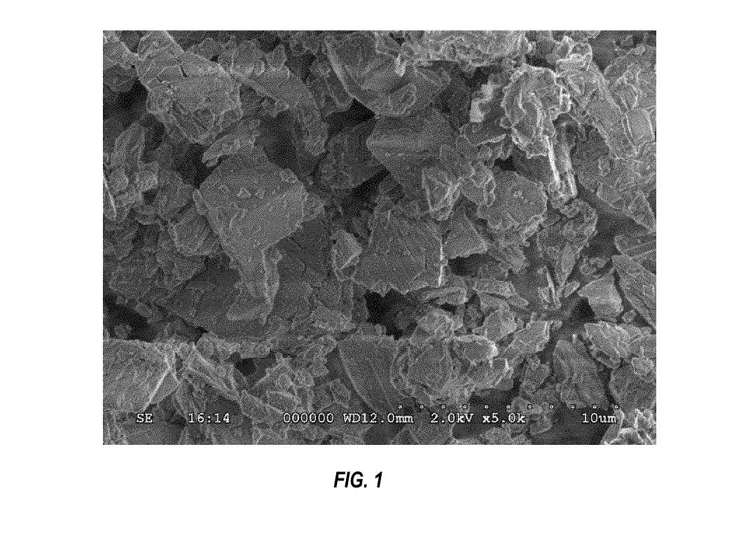

While the reactions and mechanisms described herein are theorized, such mechanisms of surface modification are supported by the enrichment of phosphorus detected on the surface of dried particles as analyzed by scanning electron microscope (SEM) and energy dispersive X-ray spectroscopy (EDX). The results of some such analysis are described in further detail below, and shown in FIGS. 1-3.

Such phenomenon could also potentially have a stabilizing effect on the rate of dissolution of the calcium carbonate particles over time, as well as on the titratable acidity (TA) levels, and pH of the food product composition. Such stabilization moderates the rate of formation and release of carbon dioxide, e.g., through a mechanism such as that seen in reactions 1-4, above. Such moderated or stabilized CO₂ generation advantageously allows maintaining stability and integrity of the packaged food product composition.

It may also be possible for calcium ions to form a relatively soluble salt with the bicarbonate ion (HCO₃⁻), e.g., formed in step 3a. Again, via the “common ion effect”, formation of this salt may serve to retard further dissolution of the calcium carbonate particles, helping to stabilize the TA level and pH of the food product composition. Such reaction is shown as reaction 8, below.

Ca²⁺+2HCO₃⁻→Ca(HCO₃)₂ (Reaction 8)

Calcium bicarbonate is much more soluble than many of the other salts described within reactions 1-6. For example, calcium bicarbonate has a solubility of about 16.6 g/100 mL at 20° C. By comparison, the solubility of calcium carbonate is only about 0.0013 g/100 mL at 25° C. Even though the solubility values are taken at slightly different temperatures, it will be appreciated that the solubility difference between the two is orders of magnitude (e.g., about 4 orders of magnitude).

Without the carbonate being tied up in a relatively low solubility form, the series of reactions such as those shown in reactions 3a, 3b, and 4 have the potential to generate CO₂ gas too quickly, in a manner that may result in generated CO₂ leaving the solution environment, and traveling to the headspace, rather than remaining largely dissolved in the food product composition. This could potentially create unacceptable levels of internal pressure within the sealed bottle. It is for these reasons that it is desirable to provide some mechanism by which the carbonate is not quickly decomposed into CO₂, but that these reactions occur very slowly, at only a moderate rate, as described herein. It is also noteworthy to point out that reactions 3a, 3b, and the generation of CO₂ in reaction 4 consume TA. If these reactions proceed too rapidly, they can potentially cause the pH of the food product composition to undesirably increase over its shelf-life, rather than remaining substantially stable. Thus, care should be taken to ensure that the modified particles are not rapidly consumed, to maintain desired TA levels, pH, and other characteristics within desired ranges.

In any case, it will be apparent that surface modification of the CaCO₃ particles occurs, whatever the particular mechanism. It will be appreciated that the various reaction mechanisms described above are thus theoretical, although the evidence presented herein is certainly consistent with such proposed mechanisms.

The weight percent ratio of Calcium (Ca) to Phosphorous (P) can be calculated and/or measured and are in the range of about 0.025 to about 6.3, assuming there are no other sources of calcium or phosphorous in the formulation other than the calcium carbonate and the phosphoric acid. If other sources are present, then the ratios can be adjusted accordingly. In any case, regardless of whether other sources of calcium or phosphorous exist, some embodiments of food product compositions of the present invention have a Ca/P ratio of between 0.025 and 6.3.

The respective weight percentages of calcium and phosphorous (and therefore the ratio of Ca/P) were measured for some exemplary formulations. Using approved AOAC methods which can be found at, e.g., the following web address (http://www.aoac.org/aoac_prod_imis/AOAC/Publications/Official_Methods_of_Analysis/A OAC_Member/Pubs/OMA/AOAC_Official_Methods_of_Analysis.aspx?hkey=5142c478-ab50-4856-8939-a7a491756f48), to digest and analyze ranch salad dressing samples via ICP Spectrometry yielded results consistent with the calculations.

C. Other Components

In addition to the above described components provided in a food product composition such as a salad dressing, various other components may be provided as would be typical in providing desired flavor and other characteristics.

For example, in salad dressing formulations, salt (sodium chloride) may be included, typically up to about 2% by weight. Of course, relatively more or less salt may be included to achieve a specific flavor. A sweetener, such as sugar, corn syrup, or other sweeteners may be added to a salad dressing to provide a sweet flavor, to decrease the perceived tartness of the dressing, or both. Of course, where a “clean” label is desired, it may be advantageous to avoid inclusion of high fructose corn syrup, other corn syrup, or other highly processed sweeteners. In such embodiments, if any sweetener is present, sugar or a non-nutritive sweetener (e.g., any of the various sugar alcohols) may be employed. Combinations of sweeteners may be employed.

An antimicrobial inhibitor (i.e., preservative) may be included, including, but not limited to a benzoate, sorbate, sorbic acid, or combinations thereof. Specific examples include, but are not limited to sorbic acid, sodium benzoate, potassium benzoate, potassium sorbate, nisin and natamycin or the like.

An exemplary salad dressing formulation may include components with weight percentages as shown in Table 1 below.

TABLE 1
Example 1

| Component | Weight Percent |
|---|---|
| Water | 30-50 |
| Edible Oil | 30-70 |
| Preservative | 0.05-5 |
| Miscellaneous | Balance |
| Phosphoric Acid | 0.2-2 |
| Other Edible Acids | 0-2 |
| Buffering Salt (e.g., CaCO₃) | 0.01-2 |

The Example shown in Table 1 includes a relatively high fraction of oil, e.g., such as may be employed in an “Original” full calorie type formulation, rather than a reduced calorie formulation. A reduced fat or reduced calorie formulation may include a lower fraction of oil, and more water, e.g., as shown below in Table 2. Of course, a fat-free formulation may include no or negligible Edible Oil component (e.g., 0%, less than 5%, less than 3%, less than 2%, or less than 1%).

TABLE 2
Example 2

| Component | Weight Percent |
|---|---|
| Water | 50-65 |
| Edible Oil | 15-30 |
| Preservative | 0.05-5 |
| Phosphoric Acid | 0.2-2 |
| Other Edible Acids | 0-2 |
| Buffering Salt (e.g., CaCO₃) | 0.01-2 |
| Miscellaneous | Balance |

“Miscellaneous” ingredients may include edible ingredients, such as those added principally for flavor, or for other purposes, and may depend on the specific flavor desired. Examples include, but are not limited to savory flavors (e.g., hydrolyzed vegetable protein, inosinates and guanylates); meat and meat flavors (e.g., bacon, bacon flavor); dairy and/or egg products (e.g., buttermilk, sour cream, blue cheese, whole egg), both liquid and dehydrated; vegetables and vegetable flavors (e.g., bell pepper, pickles, onion), fresh or dehydrated; herbs and spices (e.g., pepper, parsley, dill, thyme, sage, oregano), either fresh or dehydrated; natural or artificial flavors; extracts; emulsifiers (e.g., glycerol monostearate, diglycerol monosterate, tetraglycerol monostearate, succinic acid ester of monoglycerides, sodium stearoyl-2-lactylate, sorbitan tristate, sorbitan monostearate, sorbitan monooleate, poloxyethylene sorbitan monostearate, propylene glycol monostearate, polyoxyethylene sorbitan monooleate, diacetyl tartaric esters of monodiglycerides (DATEM), citric acid ester (CITREM), polysorbate 60, egg yolk and lecithin); gums and starches (e.g., xanthan, guar, locust bean, carrageenan) and/or other edible additives included to alter taste or to provide some other particular characteristic. Additional examples of miscellaneous ingredients that can be included in salad dressing formulations are disclosed in U.S. Pat. No. 4,927,657 to Antaki, already incorporated herein by reference.

While MSG is often included in existing food product compositions as a flavor enhancement, in at least some embodiments of the present invention, no MSG is included. As described above, the inclusion of MSG is problematic to some consumers, so that its absence may be helpful. The present inventors have found that in addition to the function as a flavor enhancement provided by MSG, that the pH of a food product composition, e.g., a salad dressing formulation, is also affected by inclusion of MSG, such that MSG actually acts as a buffer, raising the pH, where it is included. For example, all else being equal, where an exemplary “Ranch” salad dressing formulation does not include MSG, it may have a pH in a range of 2.2 to 2.9, as described herein. Such pH is considerably lower than that provided in similar salad dressing formulations containing MSG, e.g., such as those described in Antaki. Surprisingly, the inventors have found that appropriate tartness can be achieved in such dressings, even in spite of the low pH, where provision is made for in-situ generation of CO₂ as described herein. While perhaps not entirely understood, such combination allows for similar perceived tartness as with previous salad dressing formulations (e.g., Original Hidden Valley Ranch), but at lower pH.

In some embodiments, it may be possible to include MSG in the formulation. With all else being equal, the addition of the MSG results in a pH that increases from that described previously (2.2 to 2.9) by about 1 point on the pH scale, e.g., to a value within a range of about 3.2 to 3.8, or 3.4 to 3.8.

Thus, pH of the salad dressing formulation in some embodiments may be less than 3, e.g., from 2.2 to 2.9. In other embodiments, the pH of the salad dressing formulation may be 3 or greater. In any case, at least for dairy based salad dressing such as a Ranch or Blue Cheese salad dressing, the pH will be less than 4. Other types of salad dressings (Italian, French, Catalina, and the like) may have a pH value similar or somewhat different as compared to those mentioned above, even greater than pH of 4. In any case, even such other salad dressings will still have a pH less than 7.

Notably, even with the lower pH (e.g., less than 3, as described above), the TA level is actually lower than that of Antaki. Such is surprising given that Antaki's formulations have higher pH values. For example, the TA within exemplary formulations may be less than 0.85, or less than 0.84 (measured as % glacial acetic acid equivalent). TA may range from 0.75 to less than 0.85. The acetic acid equivalent is that amount of the particular acid or mixture of acids, by weight, required to obtain a titratable acidity equal to that of acetic acid. It is somewhat counter-intuitive that the present food product compositions with lower pH would also have lower TA. It is believed that the lower TA may be due at least in part to use of calcium carbonate as the buffering salt, rather than a sodium containing buffer such as disodium phosphate. In some embodiments, the food product compositions may not include sodium containing buffers, other than sodium chloride (included for taste, not buffering). In other embodiments, a small amount of another buffer in addition to the carbonate may be included, if desired. As described herein, some consumers may prefer a “cleaner” label that does not include sodium containing components, particularly where a calcium containing component may be employed instead.

In addition to such benefits, the dissolved CO₂ also may serve to decrease the bulk density of the food product composition, while at the same time being capable of release from its dissolved state in the mouth of the consumer, so as to provide an increased creamy mouth-feel. In some embodiments, the amount of calcium carbonate (or other carbonate salt, or other calcium salt) may be from 0.01% to 2%.

In some embodiments, the amount of phosphoric acid may be from 0.01% to 2%, from, 0.1% to 1%, from 0.2% to 0.8%, or from 0.5% to 0.8% (or any other values between the above ranges).

### IV. Experimental Data

The inventors performed various tests to show that the calcium carbonate particles were in fact undergoing surface modification in the presence of phosphoric acid, as theorized. SEM imaging and EDX analysis were performed on dried surface modified particles as obtained from aqueous compositions including calcium carbonate prepared using phosphoric acid. The prepared compositions were formulated to mimic the aqueous portion of the presently described salad dressing formulations. An otherwise identical aqueous composition, but which included another food grade edible acid, specifically lactic acid, was also prepared in order to determine if calcium carbonate undergoes similar surface modification when using acids other than phosphoric acid. The compositions were as shown in Table 3.

TABLE 3

| | Phosphoric Acid | Lactic Acid |
|---|---|---|
| | (wt %) | (wt %) |
| Example 3 | 1 | 0 |
| Example 4 | 0 | 0.8 |

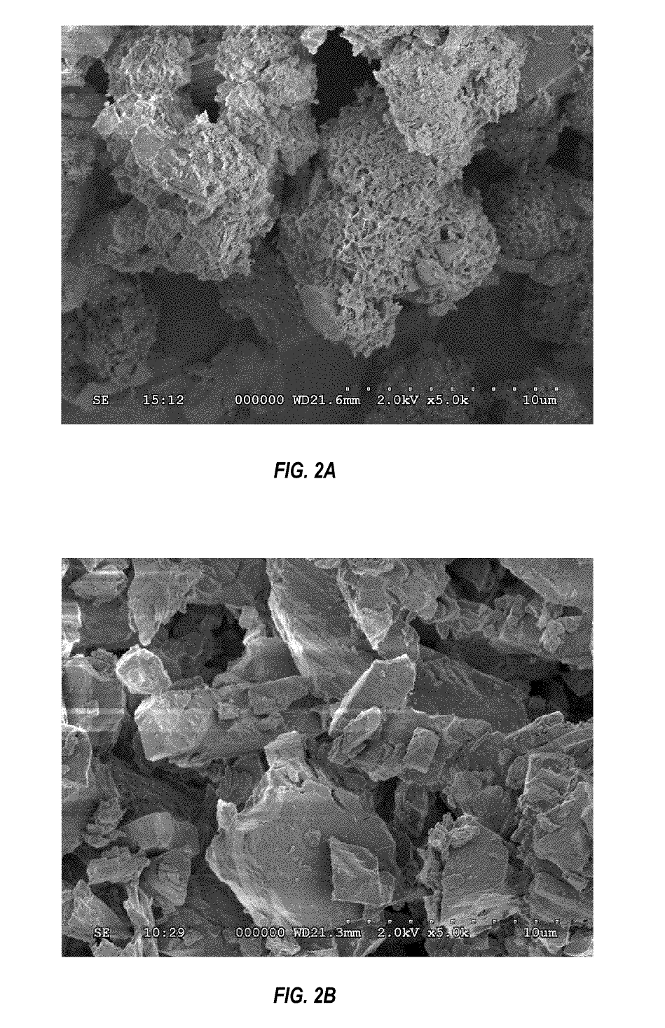

Each composition included 0.5% CaCO₃ by weight. Each of the compositions was adjusted to a pH value of about 2.6. In each example, bubbling of the samples was observed immediately during and after vigorous mixing of the composition. However, after several minutes, the calcium carbonate particles settled back to the bottom of the test tube. It was clear that in the lactic acid sample (Example 4), most of the initial calcium carbonate had been lost to dissolution into the aqueous solution. The sample with phosphoric acid (Example 3) still had a majority of solids remaining. Eventually, all samples showed bubbles on the tube walls, with solids settled at the bottom. The amount of solids remaining in the lactic acid sample (Example 4) was very small. In this sample, the solids had the consistency of a loose powder. The solids in the phosphoric acid sample (Example 3) eventually became a hardened “cake”. The solids were centrifuged, dried, and SEM imaged, the results of which are shown in FIGS. 2A and 2B. FIG. 1 is an SEM image showing the calcium carbonate particles in their neat form, before introduction into any of the sample solutions. The particles had an average size of about 4 μm. FIG. 2A shows the particles 72 hours after suspension in the aqueous solution described in Example 3, including the phosphoric acid, otherwise prepared to mimic the aqueous portion of the salad dressing formulation. The SEM image of FIG. 2A clearly shows platelets or rose-petal like structures having formed on the surface of the particles. FIG. 2B shows the leftover particles in the sample solution described in Example 4, which included no phosphoric acid, but lactic acid instead. These particles did not show the same change in surface morphology; on the contrary, these particles appeared similar to the neat block-like particles seen in FIG. 1, suggesting that these particles were excess, unreacted calcium carbonate.

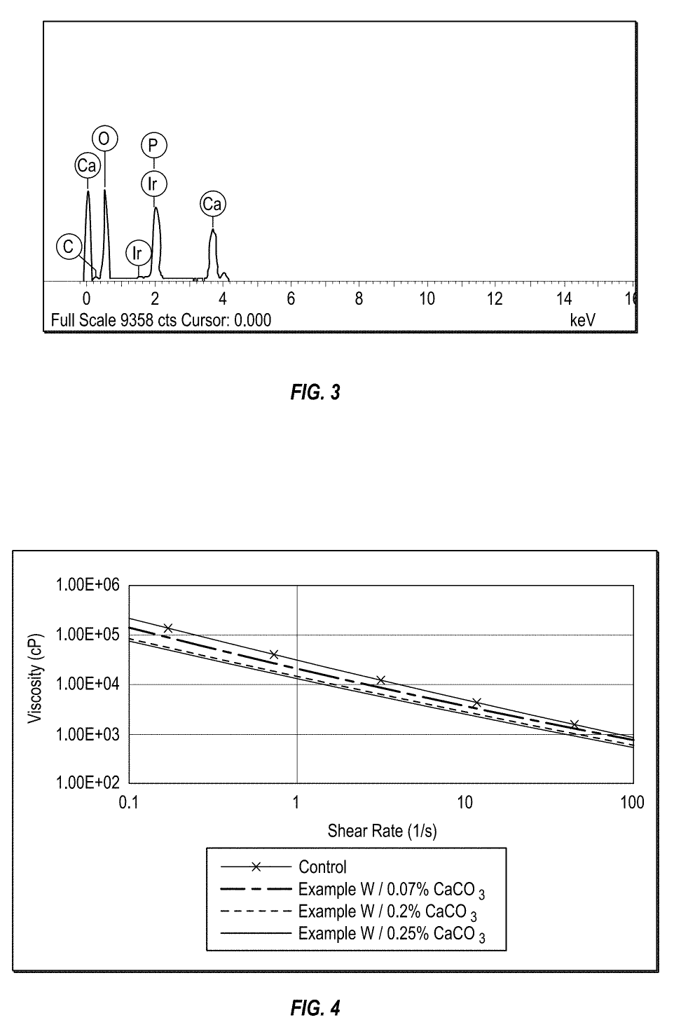

EDX elemental analysis on the surface modified particles exposed to phosphoric acid confirmed that the surface had been chemically modified, including significant fractions of phosphorus, whereas none was present prior to treatment with the phosphoric acid. The full surface composition of particles suspended in Example 3 for 72 hours is shown below in Table 4, and the composition spectrum is shown in FIG. 3. The surface of the modified particles is mainly composed of calcium, phosphorus, and oxygen, the components of calcium phosphate. A relatively low level of carbon was also detected on the surface, likely remaining from unreacted or unmodified calcium carbonate. The noted presence of iridium is a result of the sputter coating used as part of the sample preparation for SEM imaging. For comparison, Table 4 also shows the elemental composition of the particles suspended in Example 4 for 72 hours. In the absence of phosphoric acid, there is no apparent surface modification and only the calcium, carbon, and oxygen present in the original calcium carbonate can be measured.

TABLE 4

| | Atomic % after treatment | Atomic % after |
|---|---|---|
| | with phosphoric | treatment with lactic |
| Element | acid/acetic acid | acid/acetic acid |
| Carbon | 9.67 | 17.10 |
| Oxygen | 53.42 | 65.69 |
| Phosphorus | 3.24 | 0 |
| Calcium | 33.17 | 17.14 |
| Iridium | 0.17 | 0.07 |

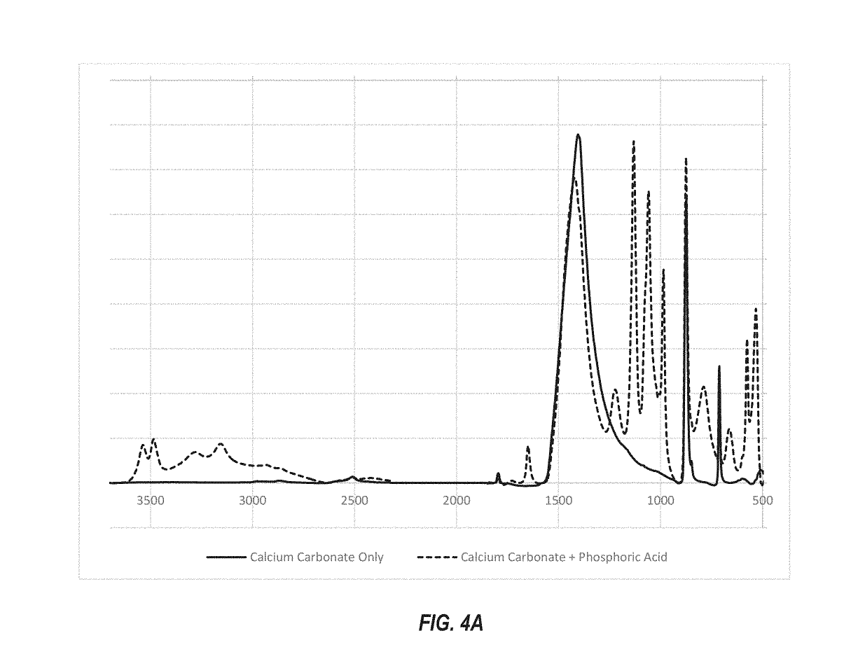

Fourier transform infrared (FTIR) spectra of the surface modified particles exposed to phosphoric acid from Example 3 shows the presence of peaks from calcium phosphate salts as well as calcium carbonate peaks whereas the untreated particles only show calcium carbonate peaks. FIG. 4A shows the FTIR spectra of untreated calcium carbonate particles and those treated with phosphoric acid. Major peaks seen in the spectrum of only calcium carbonate at 1400, 875 and 710 cm⁻¹ are indicative of calcium carbonate and additional peaks seen when calcium carbonate particles are exposed to phosphoric acid at 3530, 3480, 3272, 3150, 1215, 1130, 1060, 985, 780, 660, 575 and 535 cm⁻¹ are indicative of calcium phosphate salts.

In addition to confirming that surface modification of the calcium carbonate particles would likely be occurring in our described dressing composition, testing was performed to evaluate the rheological characteristics of exemplary salad dressing formulations including phosphoric acid and calcium carbonate. As shown in FIG. 4, these salad dressings behave as shear-thinning yield stress fluids with viscosities that decrease with increasing calcium carbonate concentration. By way of example, the formulation including 0.07% CaCO₃ exhibited a viscosity of 3370 cP at a shear rate of 10 s⁻¹ The present salad dressing formulations may generally have a viscosity from 500 cP to 50,000 cP, from 500 cP to 10,000 cP, or from 1,000 cP to about 10,000 cP, as measured at a shear rate of 10 s⁻¹. Of course, the particular viscosity may depend on the particular type of salad dressing.

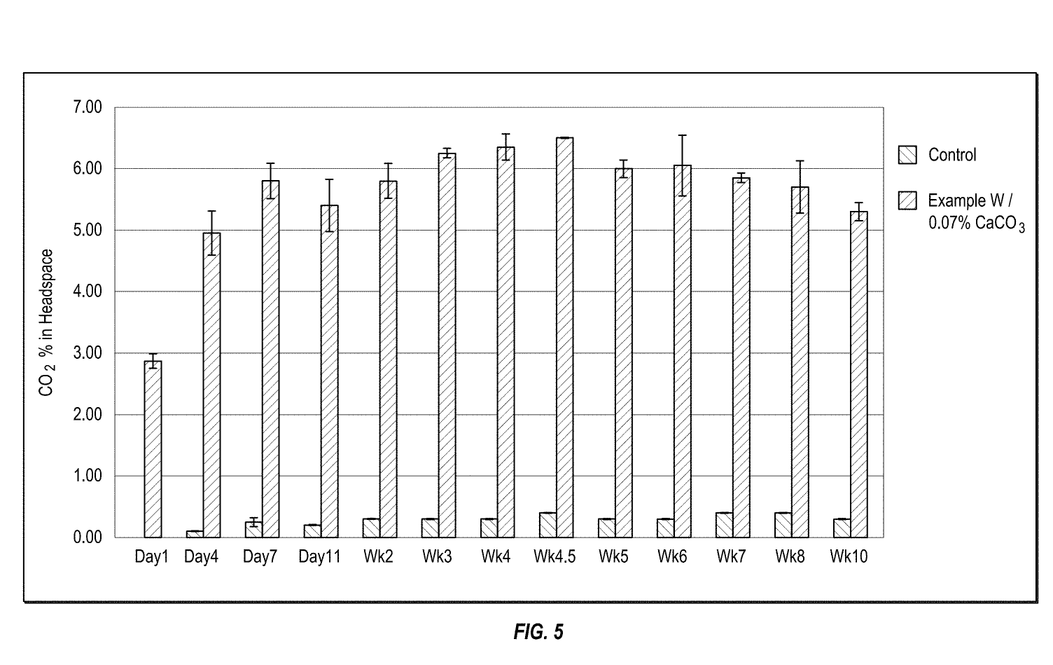

Testing was also performed to evaluate the stability characteristics of CO₂ in the headspace of packaged bottles of salad dressing over a 10 week period using a Mocon PACCHECK Model 650 Dual Headspace Analyzer. FIG. 5 shows the results of such testing, showing that examples of the inventive salad dressing compositions including phosphoric acid and calcium carbonate, even when flushed with nitrogen at the time of bottling, exhibited a relatively constant concentration of CO₂ in the headspace over the 10 week test period (e.g., not more than 15% CO₂ in the headspace, from 3% to 10% CO₂ in the headspace, from 5% to 10% CO₂ in the headspace, or from 5% to 7% CO₂ in the headspace). FIG. 5 also shows the results of comparative examples, similarly formulated, but without any calcium carbonate in the salad dressing formulation, which showed negligible CO₂ in the headspace (e.g., less than 1% CO₂, typically less than 0.5% CO₂ in the headspace. Such in-situ generated CO₂ (rather than being injected therein) is able to dissolve in the oil phase of the salad dressing, protecting the oil from oxidation, and is continually being replenished due to the continuing, slow dissolution and reaction of the surface modified calcium carbonate particles.

Testing was also performed to evaluate the microbial stability of dressings. The results of such testing, comparing various control and calcium carbonate containing formulations with varying levels of phosphoric acid have parity microbial stability results against lactic acid bacteria (LAB), even at lower acid levels up to negative 20% acid.

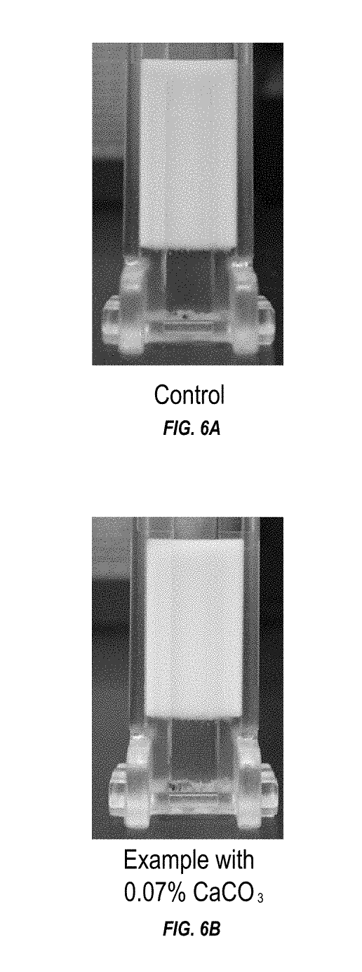

Testing was also performed to evaluate the long-term emulsion stability of an exemplary salad dressing formulation. A quantitative centrifuge (Lumisizer) was used to simulate the long-term effects of gravity to determine whether creaming or other phase separation phenomena are likely to occur. The samples were centrifuged at 4,000 rpm at 25° C. for 21 hours. FIGS. 6A-6B compare the performance of the exemplary salad dressing formulation (FIG. 6B) to a control that did not include calcium carbonate (FIG. 6A). At the conclusion of the measurement, both samples show a transparent layer of aqueous solution settled below the still-intact emulsion. In general, samples that show a thicker transparent aqueous layer at the bottom of the cell have decreased phase stability and are more likely to exhibit eventual phase separation of the oil and water in the dressing. FIGS. 6A-6B suggest that dressings containing 0.07% calcium carbonate would not have significantly poorer phase stability than a dressing that did not include calcium carbonate.

Testing was also performed to evaluate the Ca/P ratio in an exemplary salad dressing formulation of the present invention (Table 6) and a control salad dressing formulation (Table 5). The results show a Ca/P ratio between 0.025 and 6.3. Elemental Calcium and Phosphorus were determined using ICP Emission Spectrometry using the Official Methods of Analysis of AOAC INTERNATIONAL, Method 984.27, 985.01, and 2001.14, AOAC INTERNATIONAL, Gaithersburg, Md., USA.

TABLE 5
Control Dressing

| Component | Weight Percent |
|---|---|
| water | 42% |
| oil | 45% |
| disodium phosphate (buffer) | 0.15% |
| other (non-phosphate) buffers | 0.45% |
| calcium disodium EDTA | 0.0074% |
| (preservative) | |
| other preservatives | 0.2% |
| thickeners | 0.37 |
| emulsifiers | 1.5% |
| phosphoric acid 75% (acidulant) | 0.67% |
| other acidulants | 0.51% |
| Miscellaneous (e.g., flavors) | Balance |
| Total Calcium | 0.023% |
| Total Phosphorus | 0.23% |
| Ratio Ca/P | 0.1 |

TABLE 6
Exemplary Dressing

| Component | Weight Percent |
|---|---|
| water | 42% |
| oil | 45% |
| calcium carbonate (buffer) | 0.07% |
| other buffers | 0.45% |
| calcium disodium EDTA | 0.0074% |
| (preservative) | |
| other preservatives | 0.2% |
| thickeners | 0.37% |
| emulsifiers | 1.5% |
| phosphoric acid (acidulant) | 0.67% |
| other acidulants | 0.51% |
| Miscellaneous (e.g., flavors) | Balance |
| Total Calcium | 0.049% |
| Total Phosphorus | 0.2% |
| Ratio Ca/P | 0.25 |

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

1. A food composition comprising:
(a) a food ingredient list comprising oil, water, calcium carbonate, and phosphoric acid;
(b) wherein the food composition is an oil in water emulsion; and
(c) wherein the food composition has a Ca/P ratio between 0.025 and 6.4 as measured by ICP Emission Spectrometry.

2. The food composition of claim 1, having a pH of less than 3.

3. The food composition of claim 1, having a pH in a range of 2.2 to 2.9.

4. The food composition of claim 1, having a titratable acidity (TA) of less than 0.84.

5. The food composition of claim 1, having a titratable acidity (TA) in a range of 0.75 to less than 0.84.

6. The food composition of claim 1, wherein the phosphoric acid is included in an amount ranging from 0.1% to 1% by weight of the food composition.

7. The food composition of claim 1, wherein the calcium carbonate is included in an amount ranging from 0.02% to 0.3% by weight of the food composition.

8. The food composition of claim 1, wherein the food composition is free of monosodium glutamate (MSG).

9. The food composition of claim 1, wherein the food composition is free of disodium phosphate.

10. The food composition of claim 1, wherein the food composition is free of lactic acid.

11. The food composition of claim 1, wherein the CO₂ is distributed substantially homogeneously throughout the food composition in a container in which the food composition is contained.

12. The food composition of claim 1, wherein the CO₂ has a concentration in a headspace at a top of a container that is not more than 15% by volume of gases present in the headspace.

13. The food composition of claim 12, wherein the CO₂ has a concentration in the headspace that is in a range from 5% to less than 10% by volume of gases present in the headspace.

14. The food composition of claim 1, wherein the calcium carbonate ingredient has an average particle size from 1 μm to 15 μm.

15. The food composition of claim 1, further comprising a thickener, the food composition having a viscosity in a range of 1,000 centipoise to 10,000 centipoise measured at 10 s⁻¹.

16. The food composition of claim 1, wherein the ingredient list further comprises an emulsifier selected from the group consisting of glycerol monostearate, diglycerol monosterate, tetraglycerol monostearate, succinic acid ester of monoglycerides, sodium stearoyl-2-lactylate, sorbitan tristate, sorbitan monostearate, sorbitan monooleate, poloxyethylene sorbitan monostearate, propylene glycol monostearate, polyoxyethylene sorbitan monooleate, diacetyl tartaric esters of monodiglycerides, citric acid ester, polysorbate 60, egg yolk and lecithin.

17. A method for producing CO₂ in-situ comprising:
(a) combining water, oil, phosphoric acid, and calcium carbonate to form an oil in water emulsion food composition; and
(b) packaging the food composition into a container; and
(c) sealing the container to form a packaged food product having a shelf-life.

18. The method of claim 17, wherein CO₂ content in the food composition is substantially continually generated over the shelf-life of the food composition.

19. The method of claim 17, wherein CO₂ content in the headspace of the container settles to within a range of from 3% to 10% of the gases in the headspace after packaging.

20. The food composition of claim 1, wherein the food composition is a packaged food product.
